(19) United States
(12) Patent Application Publication
(10) Pub. No.: US 2003/0113616 A1
(43) Pub. Date: Jun. 19, 2003

(54) Battery and method for producing the same

(76) Inventors: Hideo Kasuga, Sumoto-shi (JP); Makoto Ochi, Myouzai-gun (JP); Toshiyuki Kondo, Tokushima-shi (JP); Hiroshi Fukuda, Naruto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/295,879

(22) Filed: Nov. 18, 2002

(30) Foreign Application Priority Data
Nov. 30, 2001 (JP) P. 2001-366307

(51) Int. Cl. H01M 2/18; H01M 2/02; H01M 6/10; H01M 10/04

(52) U.S. Cl. 429/94; 429/164; 429/130; 29/623.4

(57) ABSTRACT

A battery having: an exterior can; and an electrode body packed in the exterior can, the electrode body being formed in such a manner that a positive electrode plate and a negative electrode plate are wound into a spiral electrode shape through a separator, wherein an electrically insulating pressure sensitive adhesive tape is stuck to an end portion of the positive electrode plate and wound on the negative electrode plate at an outermost circumferential portion of the spiral electrode body to thereby fix the spiral electrode body.

### BACKGROUND OF THE INVENTION

1. Field of the Invention

The present invention relates to a battery and a method for producing the same and particularly to an alkali storage battery using a spiral electrode body.

2. Description of the Related Art

Generally, a cylindrical battery is produced by insertion of a spiral electrode body in an exterior can. The spiral electrode body is produced in such a manner that a positive electrode and a negative electrode are wound into a spiral shape through a separator. In producing the spiral electrode body, first, the separator is wound on a core in order to smoothen spirally winding, then, the positive electrode and the negative electrode are disposed through the separator, further, the two electrodes and the separator are wound spirally, and finally, the core is removed from the electrode body.

As shown in FIGS. 5 and 6, an electrode plate group constituting a cylindrical alkali storage battery such as a cylindrical nickel-cadmium battery or a cylindrical nickel-hydrogen battery has a structure in which a positive electrode plate 1 and a negative electrode plate 2 are wound into a spiral shape through a separator 3. Heretofore, as shown in FIG. 5, an electrically insulating pressure sensitive adhesive tape 4 of polypropylene or the like is stuck to a winding end of the negative electrode plate 2 and wound on an outermost circumferential portion of the electrode plate group to thereby fix the electrode plate group for the double purpose of: preventing spreading of the spiral electrode plate group at the time of carrying or packing the spiral electrode plate group in the exterior can; and preventing short-circuiting of the positive and negative electrode plates from being caused by displacement of the electrode plate group when planar positive and negative electrode collectors 5 and 6 are brought into contact with the electrode plate group and pressure-welded to the electrode plate group through weld electrodes in the condition that electrode ends of the positive and negative electrode plates in the electrode plate group are protruded up and down respectively as shown in FIG. 6.

When the fixing method was used, however, an active material in the negative electrode plate was apt to be peeled from a substrate of the negative electrode plate. Hence, there was a problem that the electrically insulating pressure sensitive adhesive tape was out of place together with the active material even in the case where the electrode plate group was fixed by the electrically insulating pressure sensitive adhesive tape. Moreover, the area of the electrically insulating pressure sensitive adhesive tape stuck to the negative electrode plate was required to be increased in order to secure fixing strength. As shown in FIGS. 7 and 8, electrical conductivity in a contact surface between the portion covered with the pressure sensitive adhesive tape 4 of polypropylene or the like and the exterior can 7 was spoiled. Hence, there was a problem that battery performance was lowered because of increase in the internal resistance of the alkali storage battery.

### SUMMARY OF THE INVENTION

The invention is provided upon such circumstances and an object of the invention is to improve fixing strength between an electrically insulating pressure sensitive adhesive tape and an electrode plate. Another object of the invention is to prevent increase in internal resistance of a battery in spite of use of an electrically insulating pressure sensitive adhesive tape to thereby improve battery performance.

According to the invention, there is provided a battery having: an exterior can; and an electrode body packed in the exterior can, the electrode body being formed in a manner so that a positive electrode plate and a negative electrode plate are wound into a spiral electrode shape through a separator; wherein an electrically insulating tape is stuck to the positive electrode plate and wound on an electrode plate group of the negative electrode plate at an outermost circumferential portion of the spiral electrode body to thereby fix the spiral electrode body.

In this configuration, because the electrically insulating tape is stuck to a winding end of the positive electrode plate which is formed so that an active material in the positive electrode plate is hardly separated from a substrate of the positive electrode plate, strong fixation can be made compared with the case where the electrically insulating tape is stuck to the negative electrode plate. Hence, in spite of a small sticking area of the positive electrode plate, fixing strength equal to that in the related-art case where the electrically insulating tape is stuck to a winding end of the negative electrode plate can be secured. Hence, reduction in internal resistance of the battery can be attained, so that improvement of battery performance can be attained.

Preferably, the electrically insulating tape is resistant to alkali.

Preferably, a ratio of an area of the electrically insulating tape wound on the outermost circumferential portion of the spiral electrode body to an area of the negative electrode on the outermost circumferential portion of the spiral electrode body (electrically insulating tape area/outermost circumferential negative electrode area) is in a range of from 20% to 80%, both inclusively.

Preferably, the positive electrode plate is a positive electrode plate of a sinter type.

Particularly in the case where the positive electrode plate is of a sinter type, an active material enters a core while a substrate constituting the core is partially exposed, so that the electrically insulating tape is hardly separated, with the result that a good fixing state can be obtained.

Also in the case where the positive electrode plate is of a non-sinter type, an active material enters a core such as foamed nickel while the core is exposed, so that the electrically insulating tape is hardly separated, with the result that a good fixing state can be obtained.

Preferably, a support of the electrically insulating tape is polypropylene.

Preferably, a support of the electrically insulating tape is polyethylene.

Preferably, the electrically insulating tape contains a pressure sensitive adhesive agent which is heat-curable.

Further, according to the invention, there is provided a method of producing a battery having an electrode body packed in an exterior can and formed in a manner so that a positive electrode plate and a negative electrode plate are wound into a spiral electrode shape through a separator, having the steps of: sticking an electrically insulating tape to the positive electrode plate; and winding the electrically insulating tape on an electrode plate group of the negative electrode plate at an outermost circumferential portion of the spiral electrode body to thereby fix the spiral electrode body.

In this method, strong fixation can be made by a simple operation of sticking the electrically insulating tape to the positive electrode plate, so that a large-current battery can be produced easily.

### BRIEF DESCRIPTION OF THE DRAWINGS

FIG. 1 is a view showing an electrode plate group according to the invention for explaining a state in which an electrically insulating pressure sensitive adhesive tape is stuck onto a positive electrode plate.

FIG. 2 is a view schematically showing a spiral electrode body constituting a cylindrical alkali storage battery according to the invention.

FIG. 3 is a view showing the interior of an exterior can of the cylindrical alkali storage battery according to the invention.

FIG. 4 is a sectional view showing the cylindrical alkali storage battery in which the electrically insulating pressure sensitive adhesive tape is stuck onto the positive electrode plate according to the invention.

FIG. 5 is a view showing an electrode plate group constituting a related-art cylindrical alkali storage battery.

FIG. 6 is a view schematically showing a spiral electrode body constituting the related-art cylindrical alkali storage battery.

FIG. 7 is a view showing the interior of an exterior can of the related-art cylindrical alkali storage battery.

FIG. 8 is a sectional view of the related-art cylindrical alkali storage battery.

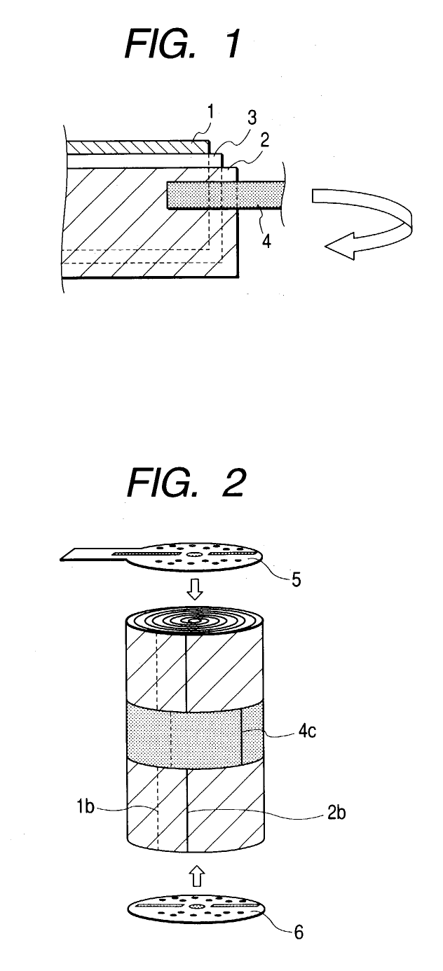

### DESCRIPTION OF THE PREFERRED EMBODIMENTS

An electrically insulating pressure sensitive adhesive tape used in the invention has a release sheet layer as an outermost layer, a support film layer, and a pressure sensitive adhesive layer made of a pressure sensitive adhesive agent and formed between the release sheet layer and the support film layer. Examples of the pressure sensitive adhesive agent may include natural rubber, acrylic resin, ethylene-vinyl acetate copolymer, polyurethane, polyester, silicone rubber, fluoro rubber, polyvinyl butyral, isobutylene, mixtures thereof, and copolymers of various kinds of monomers constituting various kinds of pressure sensitive adhesive agents. Particularly, a pressure sensitive adhesive agent which is heat-curable is preferably used. For example, a tackifier, a tackiness adjusting agent, an age resister, a stabilizer, or a colorant may be preferably mixed with the pressure sensitive adhesive agent. It is also preferable that the pressure sensitive adhesive agent is resistant to alkali. The thickness of the pressure sensitive adhesive layer is selected to be in a range of from 3 to 1000 μm, preferably in a range of from 5 to 500 μm.

Any layer can be used as the release sheet layer if the pressure sensitive adhesive agent can be separated easily. For example, a plastic sheet such as a polyethylene terephthalate sheet, a sheet of paper, a sheet of cloth or a plastic sheet treated with a releasant (silicone, wax, fluorine or the like) can be generally used as the release sheet layer. The thickness of the release sheet layer is selected to be in a range of from 1 to 500 μm, preferably in a range of from 3 to 300 μm.

Examples of the material of the support film layer include thermoplastic resins such as polyamide, polyethylene, polypropylene, polyisobutylene, polybutadiene, polyvinyl acetate, polyvinyl chloride, polyethylene terephthalate (PET), Nylon, polystyrene, polyurethane, polycarbonate (PC), polyvinyl alcohol (PVA), ethylene-vinyl alcohol copolymer, polycarbonate, polyacetal, AS resin, ABS resin, melamine resin, acrylic resin, epoxy resin and polyester resin. Particularly, polyamide, polyethylene, polypropylene, PET, Nylon or polycarbonate is preferably used, and a material resistant to alkali is more preferably used.

The thickness of the plastic film used as the support film is selected to be in a range of from 3 to 300 μm, preferably in a range of from 5 to 200 μm.

Preferably, the plastic film may contain an ultraviolet absorber, a filler, a heat stabilizer, a colorant, etc. Further, a surface treatment such as a corona discharge treatment may be applied to a surface of the support film.

Further, a surface of the support film on a side opposite to the layer having the pressure sensitive adhesive agent may be coated with a coating composition capable of forming a coating film having a low friction coefficient. For example, the coating composition may be prepared in such a manner that fine particles of a fluoro-based resin, a silicone resin or the like are dispersed into a lacquer composition of a polyester resin, an acrylic resin or the like, or into a crosslinkable composition of a polyester resin, an acrylic resin or the like mixed with a curing agent such as an amino resin or a polyisocyanate compound. Alternatively, the coating composition may be prepared in such a manner that additives such as silicone oil, silicone resin, fluoro resin, fluorine oil, and wax are added into the lacquer or crosslinkable composition or into a coating composition prepared in such a manner that the fine particles are mixed with the lacquer or crosslinkable composition.

The electrically insulating pressure sensitive adhesive tape used in the invention is generally stuck in parallel with the winding direction of the electrode plates. A start point of sticking is on the positive electrode plate and at a distance of 5 to 20 mm, preferably at a distance of 5 to 10 mm from an end portion (winding end) of the positive electrode plate.

When the electrically insulating pressure sensitive adhesive tape is wound on the negative electrode at the outermost circumference, the ratio of the area of the tape on the outermost circumference to the area of the negative electrode on the outer circumference (outermost circumference tape area/outermost circumference negative electrode area) is selected to be in a range of from 20% to 80%, preferably in a range of from 25% to 75%.

The storage battery according to the invention is particularly effectively applied to a cylindrical alkali storage battery such as a nickel-hydrogen storage battery having a sinter type positive electrode plate. The invention may be also applied to a lithium battery, a primary battery or a secondary battery. It is a matter of course that the invention can be also applied to a rectangular pipe type storage battery if the storage battery is shaped like a pipe.

The invention is preferably applied to a nickel-hydrogen storage battery.

An embodiment of the invention will be described below in the case where the invention is applied to a nickel-hydrogen storage battery.

1. Production of Electrode Body

A nickel-hydrogen storage battery has a nickel positive electrode plate, and a hydrogen absorbing alloy negative electrode plate. The nickel positive electrode plate is produced in such a manner that after a nickel sintered porous body is formed on a surface of an electrode plate core made of a punching metal, the nickel sintered porous body is filled with an active material containing nickel hydroxide as a main component by a chemical impregnating method. On the other hand, the hydrogen absorbing alloy negative electrode plate is produced in such a manner that after a surface of an electrode plate core made of a punching metal is filled with a paste-like negative electrode active material of a hydrogen absorbing alloy, the paste-like negative electrode active material is dried and rolled into a predetermined thickness.

While a separator is interposed between the nickel positive electrode plate and the hydrogen absorbing alloy negative electrode plate, these electrode plates are spirally wound to produce a spiral electrode body. An end of the electrically insulating pressure sensitive adhesive tape 4 is stuck to the nickel positive electrode plate 1. The electrically insulating pressure sensitive adhesive tape 4 is wound on the spiral electrode body and fixed at a winding end 4c. An end portion of the punching metal which is an electrode plate core of the nickel positive electrode plate is exposed at an upper end surface of the spiral electrode body. An end portion of the punching metal which is an electrode plate core of the hydrogen absorbing alloy negative electrode plate is exposed at a lower end surface of the spiral electrode body. A disk-like collector body portion having a large number of openings is welded to the positive electrode core exposed at the upper end surface of the spiral electrode body. A disk-like negative electrode collector having a large number of openings is welded to the negative electrode core exposed at the lower end surface of the spiral electrode body. In this manner, the spiral electrode body is produced.

2. Production of Nickel-Hydrogen Storage Battery

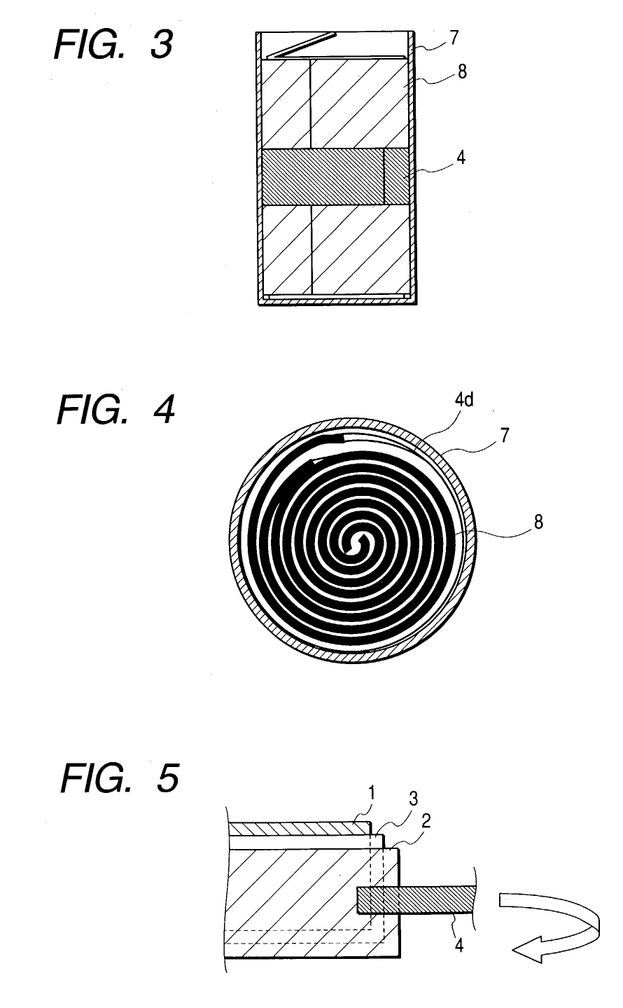

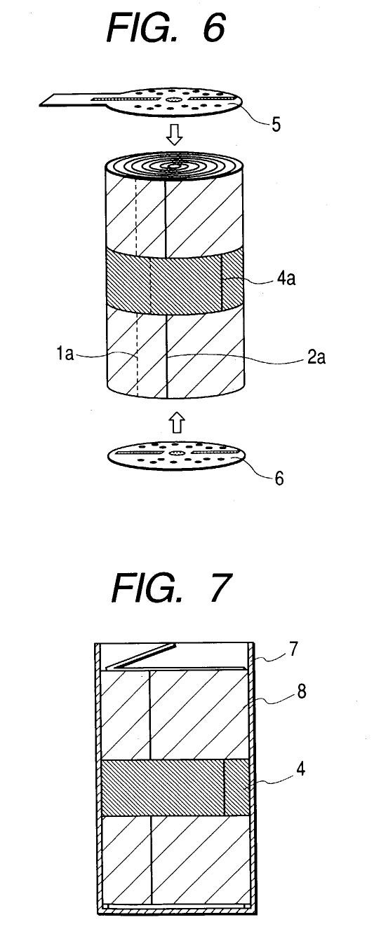

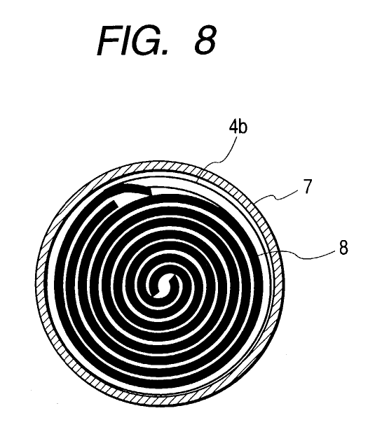

FIG. 3 is a sectional conceptual view showing a state in which the electrode body is inserted in an exterior casing and welded to a seal cap through a collector lead. An opening portion of the exterior can is sealed with the seal cap. Then, the sealing portion is pressed.

The collector lead is used so that the nickel-hydrogen storage battery is assembled as follows. First, the electrode body is put into a bottomed pipe-like exterior casing of nickel-plated iron (using an outer bottom surface as a negative electrode external terminal). A weld electrode is inserted in a space portion formed in the central portion of the electrode body. The negative electrode collector welded to the hydrogen absorbing alloy negative electrode plate is spot-welded to an inner bottom surface of the exterior casing through the weld electrode. Then, a body portion of the collector lead is put so as to be positioned on the diameter of a collector body portion of the collector lead as a positive electrode collector. The collector body portion and the positive electrode are spot-welded to each other.

After the collector lead and the collector body portion are welded to each other thus, a vibration-proof ring is inserted in the upper inner circumferential side of the exterior casing and a grooving treatment is applied to the outer circumferential side of the exterior casing to thereby form an annular groove at an upper end portion of the vibration-proof ring. Then, after an electrolytic solution constituted by an aqueous solution containing 30% by weight of potassium hydroxide (KOH) is injected into the exterior casing, a seal cap having an electrically insulating gasket fitted to its circumferential edge is disposed on an upper portion of the opening of the exterior casing. In this case, the seal cap is disposed so that a bottom surface of the seal cap comes into contact with a weld surface of the collector lead. Incidentally, the seal cap has a cover for forming a circularly downward protrusion in its bottom surface, a positive electrode cap (positive electrode external terminal), and a valve interposed between the cover and the positive electrode cap. The valve has a spring, and a valve plate. A gas vent hole is formed in the center of the cover.

After the seal cap is disposed as described above, one weld electrode is disposed on the upper surface of the positive electrode cap (positive electrode external terminal) and the other weld electrode is disposed on the lower surface of the bottom (negative electrode external terminal) of the exterior casing. Then, while a pressure of 2×10⁶ N/m² is applied between the pair of weld electrodes, a voltage of 24 V is applied between the pair of weld electrodes in a discharging direction of the battery to thereby perform a current conduction treatment in which a current of 3 kA flows for a time of about 15 msec. By the current conduction treatment, the bottom of the seal cap and the protrusion of the weld surface of the collector lead are welded to each other at a contact portion between the two to thereby form a welded portion.

Then, the end edge of the opening of the exterior casing is caulked inward to seal the battery to thereby obtain a semi-finished battery. Then, the semi-finished battery is disposed in a pair of split molds and a punch linked to a press machine is disposed above the seal cap. Then, the press machine is driven to move down the punch to thereby press the seal portion (end edge of the opening of the exterior casing) of the seal cap to force the seal cap into the exterior casing. In this manner, a cylindrical nickel-hydrogen storage battery having a nominal capacity of 6.5 Ah is produced.

Any material may be used as each collector for carrying an electrode active material if the material is an electronic conductor which is chemically unchanged in the battery formed thus. For example, stainless steel, nickel, aluminum, titanium or sintered carbon can be used as the material of the positive electrode collector. Alternatively, aluminum or stainless steel having a surface treated with carbon, nickel, titanium or silver may be used as the material of the positive electrode collector. For example, stainless steel, nickel, copper, titanium, aluminum or sintered carbon can be used as the material of the negative electrode collector. Alternatively, copper or stainless steel having a surface treated with carbon, nickel, titanium or silver, or Al—Cd alloy may be used as the material of the negative electrode collector. These materials may has surfaces oxidized. Examples of the shape of each collector include a foil shape, a film shape, a sheet shape, a net shape, a punched shape, a lath shape, a porous shape, a foam shape, and a fiber group molded shape. The thickness of each collector is not particularly limited. Generally, each collector having a thickness of from 1 to 500 μm is used.

An electrically insulating porous thin film having a high ion permeability and a predetermined mechanical strength is used as the electrode separator. A porous sheet or a sheet of nonwoven fabric made of an olefin-based polymer such as polypropylene, glass fiber, polyethylene, or the like is used in terms of organic solvent resistance and hydrophobic property. For example, the pore size of the separator is in a range of from 0.01 to 10 μm, which is generally used for the battery. The thickness of the separator is selected to be in a range of from 5 to 300 μm.

The purpose of use of the storage battery according to the invention is not particularly limited. For example, the storage battery may be mounted in an electronic appliance such as a color notebook personal computer, a pen-input personal computer, a pocket personal computer, a notebook word processor, a pocket word processor, an electronic book player, a cellular phone, a cordless auxiliary phone, a pager, a handy terminal, a portable facsimile machine, a portable copy machine, a portable printer, a headphone stereo sound system, a video movie system, a liquid-crystal television set, a handy cleaner, a portable CD player, a mini-disc player, an electric shaver, an electronic translating machine, a mobile telephone system, a transceiver, an electric power tool, an electronic notebook, an electric calculator, a memory card, a tape recorder, a radio receiver, a backup power supply or a memory card. For example, the storage battery may be also mounted in a household electronic appliance such as an automobile, an electric vehicle, a motor, a lighting apparatus, a toy, a game machine, a road conditioner, an iron, a watch, a strobe, a camera or a medical machine. Alternatively, the storage battery according to the invention may be used in combination with a solar battery.

### EXAMPLES

The invention will be described below more in detail on the basis of the following examples but the invention is not limited to the examples.

### Examples 1 to 3

A spiral electrode body was produced by the storage battery producing method in the condition that a start point of tape sticking was set at a winding end of a positive electrode plate and that an electrically insulating pressure sensitive adhesive tape having a support of polypropylene was wound on an outermost circumferential portion of an electrode plate group to thereby fix the-electrode plate group so that the percentage occupied by the tape area was 25% in Example 1 (50% in Example 2 or 75% in Example 3). The spiral electrode body was packed in an exterior can to thereby produce a cylindrical alkali storage battery. Table 1 shows the relation between the position where the tape was stuck and the area ratio in the invention.

Table 1

TABLE 1
Tape Sticking Position and Tape Area Ratio in the Invention

| | Example 1 | Example 2 | Example 3 |
|---|---|---|---|
| Tape Sticking | Positive | Positive | Positive |
| Position | Electrode | Electrode | Electrode |
| Tape Area Ratio | 25% | 50% | 75% |

(*Note)
“Tape Area Ratio” is a numerical value expressing the “ratio of the area of the tape to the area of the negative electrode on the outermost circumference” in %, as shown in the above.

### Comparative Examples 1 to 3

Storage batteries were produced in the same condition as in Examples 1 to 3. In each of Comparative Examples 1 to 3, the position where the tape was stuck was set at a winding end of the negative electrode plate in the related-art manner as shown in FIG. 5. The tape was wound on the outermost circumferential portion of the electrode plate group to thereby fix the electrode plate group so that the percentage occupied by the tape area was 25% in Comparative Example 1 (50% in Comparative Example 2 or 75% in Comparative Example 3). Table 2 shows the relation between the position where the tape was stuck and the area ratio.

Table 2

TABLE 2
Tape Sticking Position and Tape Area Ratio in Comparative Examples

| | Comparative | Comparative | Comparative |
|---|---|---|---|
| | Example 1 | Example 2 | Example 3 |
| Tape Sticking | Negative | Negative | Negative |
| Position | Electrode | Electrode | Electrode |
| Tape Area Ratio* | 25% | 50% | 75% |

6. Incidence of Tape Peeling Failure

Comparison was made in the incidence of failure in which the tape wound on the outermost circumferential portion of the electrode plate group was peeled so that the electrode plate group was spread.

7. Battery Characteristic Test

(1) Measurement of Internal Resistance

The internal resistance of the battery assembled in such a manner that the electrode plate group was inserted in the exterior can was measured by an AC impedance method.

Measurement of Frequent Discharge Characteristic

(1) Activation

The cylindrical alkali storage battery produced in each of Examples and Comparative Examples was used to be charged at a current value of 650 mA (0.1 It) at room temperature (about 25° C.) for 8 hours. Then, the battery was rested for 1 hour. Then, the battery was discharged at a current of 1300 mA (0.2 It) to reduce the voltage to 0.8 V. In this manner, one charge-discharge cycle was formed. The charge-discharge cycle was repeated by 10 times to activate the battery.

(2) V-I Characteristic Test

Then, the cylindrical alkali storage battery activated as described above and having a state in which the battery was discharged at a current of 1300 mA (0.2 It) to reduce the voltage to 0.8 V was charged at a current of 1300 mA (0.2 It) at room temperature (about 25° C.) for 3 hours. Then, the battery was rested for 1 hour. Then, the battery was discharged at a current of 25 A for 30 seconds. After 10 seconds, the voltage of the battery was measured.

Then, the battery was charged with electric power by the discharged capacity. Then, the battery was discharged at a current of 50 A, 70 A or 100 A for 30 seconds in the same manner. After 10 seconds, the voltage of the battery was measured. V-I characteristic was obtained on the basis of the voltage of the battery measured thus after 10 seconds.

Table 3

Table 3
Evaluation Result of Storage Battery in the Invention

| | Example 1 | Example 2 | Example 3 |
|---|---|---|---|
| Incidence of Tape | 0.08 | 0 | 0 |
| Peeling Failure (%) | | | |
| Internal Resistance (mΩ) | 3.50 | 3.58 | 3.63 |
| Frequent Discharge | 94 | 91 | 88 |
| Characteristic 0.2 It | | | |
| capacity ratio (%) | | | |
| Operating Voltage (V) | 0.940 | 0.932 | 0.924 |

TABLE 4
Evaluation of Result of Storage Battery in Comparative Examples

| | Comparative | Comparative | Comparative |
|---|---|---|---|
| | Example 1 | Example 2 | Example 3 |
| Incidence of Tape | 0.12 | 0.03 | 0 |
| Peeling Failure (%) | | | |
| Internal Resistance | 3.50 | 3.58 | 3.63 |
| (mΩ) | | | |
| Frequent | | | |
| Discharge | | | |
| Characteristic 0.2It | 94 | 91 | 88 |
| capacity ratio (%) | | | |
| Operating Voltage | 0.940 | 0.932 | 0.924 |
| (V) | | | |

As is obvious from Tables 3 and 4, the electrically insulating pressure sensitive adhesive tape is hardly peeled in the case of the positive electrode plate formed in such a manner that Ni slurry applied on a core is sintered and filled with an active material by chemical impregnation. Also in the case of the non-sintered positive electrode plate formed in such a manner that Ni slurry and a binder applied on foamed Ni (three-dimensional sintered body) is dried and filled with an active material, the electrically insulating pressure sensitive adhesive tape is hardly peeled when the foamed Ni is exposed to the surface. On the other hand, it is apparent that the electrically insulating pressure sensitive adhesive tape is easily peeled

What is claimed is:

1. A battery comprising:
an exterior can; and
an electrode body packed in said exterior can, said electrode body being formed in a manner so that a positive electrode plate and a negative electrode plate are wound into a spiral shape through a separator;
wherein an electrically insulating tape is stuck to said positive electrode plate and wound on an electrode plate group of said negative electrode plate at an outermost circumferential portion of said spiral electrode body to thereby fix said spiral electrode body.

2. A battery according to claim 1, wherein said electrically insulating tape is resistant to alkali.

3. A battery according to claim 1 or 2, wherein a ratio of an area of said electrically insulating tape wound on said outermost circumferential portion of said spiral electrode body to an area of said negative electrode on said outermost circumferential portion of said spiral electrode body (electrically insulating tape area/outermost circumferential negative electrode area) is in a range of from 20% to 80%, both inclusively.

4. A battery according to any one of claims 1 through 3, wherein said positive electrode plate is made of a sintered body.

5. A battery according to any one of claims 1 through 4, wherein said electrically insulating tape is a pressure sensitive adhesive tape.

6. A battery according to any one of claims 1 through 5, wherein said electrically insulating tape contains a pressure sensitive adhesive agent which is heat-curable.

7. A method of producing a cylindrical battery having an electrode body packed in an exterior can and formed in a manner so that a positive electrode plate and a negative electrode plate are wound into a spiral electrode shape through a separator, comprising the steps of:
sticking an electrically insulating tape to said positive electrode plate; and
winding said electrically insulating tape on an electrode plate group of said negative electrode plate at an outermost circumferential portion of said spiral electrode body to thereby fix said spiral electrode body.
